(19) United States
(12) Patent Application Publication
(10) Pub. No.: US 2025/0383507 A1
(43) Pub. Date: Dec. 18, 2025

(54) OPTICAL COMPONENT, OPTICAL MODULE, AND METHOD FOR MANUFACTURING OPTICAL COMPONENT

(71) Applicant: BROWAVE CORPORATION, HSINCHU COUNTY (TW)

(72) Inventors: Wei-Jen CHOU, HSINCHU CITY (TW); Yo-You HSU, HSINCHU CITY (TW); Pao-Shan HSU, HSINCHU CITY (TW)

(21) Appl. No.: 19/026,967

(22) Filed: Jan. 17, 2025

Related U.S. Application Data
(60) Provisional application No. 63/659,696, filed on Jun. 13, 2024.

(51) Int. Cl. G02B 6/32

(52) U.S. Cl. CPC G02B 6/322

(57) ABSTRACT

An optical component is provided. The optical component includes a lens body having a first side and a second side opposite to the first side. The lens body includes a lens structure, a first engaging structure, a second engaging structure and a notch structure. The lens structure is located at the first side of the lens body. The first and the second engaging structures are located at the first side of the lens body, a profile of the first engaging structure is engageable with a profile of the second engaging structure, and the first and the second engaging structures are located at two opposite sides of the lens structure. The notch structure is located at the second side of the lens body, and the notch structure has a sidewall vertically aligned with the lens structure. An optical module and a method for manufacturing an optical component are also provided.

### PRIORITY CLAIM AND CROSS-REFERENCE

This application claims the benefit of prior-filed U.S. provisional application No. 63/659,696, filed Jun. 13, 2024, and incorporates them entirety herein.

### FIELD

The present disclosure relates to an optical component and an optical module and the manufacturing method thereof, particularly, the optical component and optical module is for optical fiber-to-chip interconnection application.

### BACKGROUND

Nowadays, with the rapid development of optical communication technology, the optical communication technology based on integrated optical devices is developing toward a trend of high speed, broad bandwidth, low power consumption, and small size application. Co-Packaged Optics (CPO) is an advanced heterogeneous integration of optical device and silicon-based electronics on a single packaged substrate aimed at addressing next generation bandwidth and power challenges. CPO brings together a wide range of expertise in fiber optics, digital signal processing (DSP), switch ASICs, and state-of-the-art packaging & test to provide disruptive system value for the data center and cloud infrastructure.

### BRIEF DESCRIPTION OF THE DRAWINGS

Aspects of the present disclosure are best understood from the following detailed description when read with the accompanying figures. It is noted that, in accordance with the standard practice in the industry, various structures are not drawn to scale. In fact, the dimensions of the various structures may be arbitrarily increased or reduced for clarity of discussion.

FIG. 1 illustrates a cross-sectional view of an optical component according to some embodiments of the present disclosure.

FIG. 2 illustrates a cross-sectional view of an optical component according to some embodiments of the present disclosure.

FIG. 3 illustrates a cross-sectional view of an optical component according to some embodiments of the present disclosure.

FIG. 4 illustrates a cross-sectional view of an optical module according to some embodiments of the present disclosure.

FIG. 5 illustrates a cross-sectional view of an optical module according to some embodiments of the present disclosure.

FIG. 6A illustrates a cross-sectional view of an optical module according to some embodiments of the present disclosure.

FIG. 6B illustrates a cross-sectional view of an optical module according to some embodiments of the present disclosure.

FIG. 7A illustrates a three-dimensional view of an optical module according to some embodiments of the present disclosure.

FIG. 7B illustrates a three-dimensional view of an optical module according to some embodiments of the present disclosure.

FIG. 8 illustrates a flow chart of a method for manufacturing an optical component according to some embodiments of the present disclosure.

FIGS. 9A to 9H illustrate cross-sectional views of forming an optical component according to some embodiments of the present disclosure.

FIGS. 9I and 9J illustrate cross-sectional views of forming an optical component according to some embodiments of the present disclosure.

FIG. 10A illustrates a top view of an optical component according to some embodiments of the present disclosure.

FIG. 10B illustrates a bottom view of an optical component according to some embodiments of the present disclosure.

FIG. 11 illustrates a top view of a plurality of optical components being integrated into a CPO platform according to some embodiments of the present disclosure.

### DETAILED DESCRIPTION

The following disclosure provides many different embodiments, or examples, for implementing different features of the provided subject matter. Specific examples of elements and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper”, “on,” and the like, may be used herein for case of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

As used herein, the terms such as “first,” “second,” and “third” describe various elements, components, regions, layers and/or sections, these elements, components, regions, layers and/or sections should not be limited by these terms. These terms may be only used to distinguish one element, component, region, layer or section from another. The terms such as “first,” “second,” and “third” when used herein do not imply a sequence or order unless clearly indicated by the context.

In the technical field of fiber-optic communication, an optical fiber-to-chip interconnection component is used to couple the optical signal transmitted in the optical fiber into the optical chip, and serve as an important component in packaging optical chips and electronic circuit chips together on a carrier board. Specific designs of the interconnection component between optical chip and optical fiber can be developed to meet different requirements in various application schemes. Conventionally, the optical fiber-to-chip interconnection component may have issues of occupying a lot of space (not compact), beam alignment being challenging and the light transmitting efficiency being low, the installation being not stable and secure, and the integration being not easy to use and maintain, etc. The present disclosure provides an optical component and optical module for optical fiber-to-chip interconnection application and can be used to address the issues described above.

In some embodiments of the present disclosure, an optical component and an optical module for optical fiber-to-chip interconnection is provided. Such optical component and optical module can be used for interconnection between optical chips (e.g. photonic integrated circuit) and optical fibers (e.g. fiber unit array) with a function of directional change to the optical path of the light beam. In some embodiments of the present disclosure, a manufacturing method of the optical component and the optical module for optical fiber-to-chip interconnection is provided. Such manufacturing method can be used for manufacturing a designated optical component that is suitable for interconnection between optical chips and optical fibers, for example, the edge coupling for optical fibers and optical chips.

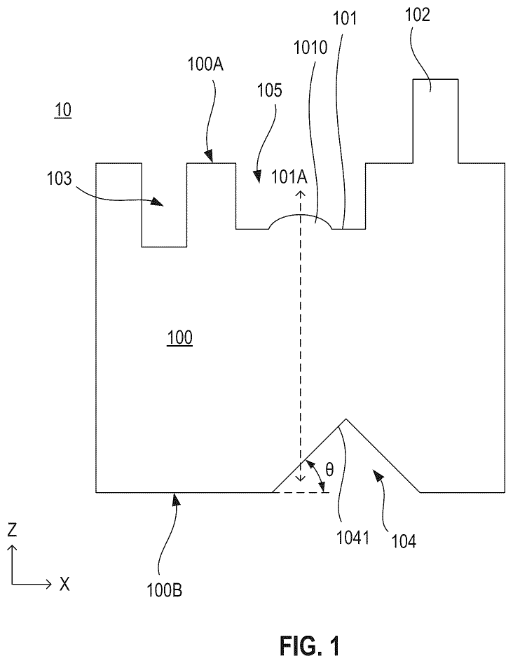

Referring to the cross-sectional view of an optical component for interconnecting optical chips and optical fiber (or briefly called an optical component 10) shown in FIG. 1, in some embodiments, the optical component 10 includes a lens body 100 having a first side 100A and a second side 100B opposite to the first side 100A. The lens body 100 includes a lens structure 101, a first engaging structure 102, a second engaging structure 103 and a notch structure 104. The lens structure 101 is located at the first side 100A of the lens body 100. The first engaging structure 102 and the second engaging structure 103 are also located at the first side 100A of the lens body 100, a profile of the first engaging structure 102 is engageable with a profile of the second engaging structure 103, and the first engaging structure 102 and the second engaging structure 103 are located at two opposite lateral sides of the lens structure 101. The notch structure 104 is located at the second side 100B of the lens body 100, and the notch structure 104 has a sidewall 1041 vertically aligned with the lens structure 101.

For convenience of explanation, figures in the present disclosure may include X-Y-Z coordinate to specify the orientation or direction relation in various embodiment, but the present disclosure is not limited to these examples. In some embodiments, the lens body 100 may be formed by a substrate including material (e.g., silicon or silicon dioxide) that is transparent to some corresponded wavelength range (e.g., infrared light), so as to guide the light beam between the optical fiber and the chip. Also, the material of the lens body 100 may be suitable for semiconductor manufacturing process. The size and dimension of the lens body 100 may be determined by some feature sizes of detailed structures therein. For example, the size and dimension of the lens body 100 may depend on the feature sizes of the lens structure 101, the first engaging structure 102, the second engaging structure 103 and the notch structure 104.

In some embodiments, the lens structure 101 includes a lens-containing recess 105 at the first side 100A of the lens body 100. In some embodiments, the lens structure 101 includes a convex lens 1010 at the bottom of the lens-containing recess 105 located at the first side 100A. The convex lens 1010 can be used to converge and collimate the light beam. In other embodiments, the lens portion of the lens structure 101 can have other shape for distinct use. For example, in other embodiments, the lens structure 101 may include a concave lens or a Fresnel lens to collimate the light beam based on the optical path of the light beam. The focal length of the lens structure 101 can be determined by the radius of curvature of the curving surface of the lens portion of the lens structure 101, and the diameter (or width) of the lens portion of the lens structure 101 can be determined based on the width of the incident light beam profile. In some embodiments, the lens portion of the lens structure 101 is located at a center position of the first side 100A from a cross-sectional perspective, in particular at a center position along the X-axis direction.

In some embodiments, the first engaging structure 102 and the second engaging structure 103 are paired engaging structures located at the first side 100A of the lens body 100. In some embodiments, the first engaging structure 102 includes a protrusion profile (e.g., a protrusion portion), while the second engaging structure 103 includes a recess profile (e.g., a receptacle recess). In some embodiment, a profile of the first engaging structure 102 is engageable with a profile of the second engaging structure 103. In some embodiment, the protrusion and recess profiles of the first engaging structure 102 and the second engaging structure 103 may have the same geometry, such as cylinder, rectangular cuboid, trapezoid column, etc., when viewed from a cross-sectional perspective, in order to achieve the engaging purpose between them. The first engaging structure 102 and the second engaging structure 103 may be located at two opposite sides of the lens structure 101 along the X-axis direction. In some embodiments, the lens structure 101 may be located between the first engaging structure 102 and the second engaging structure 103. In some embodiments, a bottom of the first engaging structure 102 is leveled with a top of the second engaging structure 103. For instance, the first engaging structure 102 protrudes from a surface of the lens body 100, while the second engaging structure 103 recesses from the surface of the lens body 100.

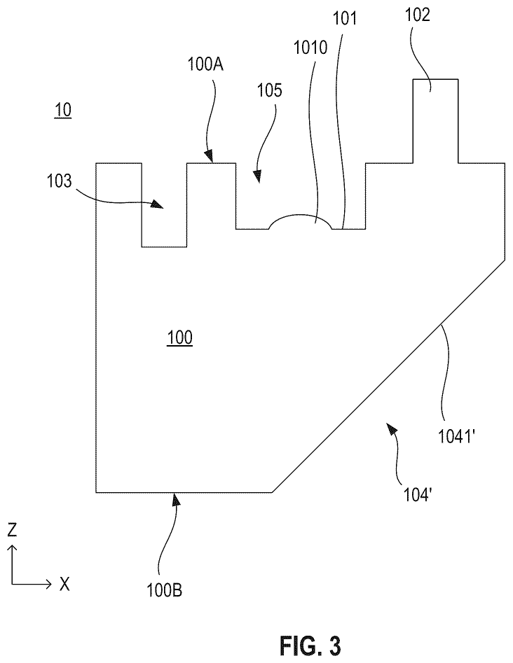

In some embodiments, the engaging structures (i.e., the first engaging structure 102 and the second engaging structure 103) and the notch structure 104 are located at two opposite sides of the lens body 100. In some embodiments, the sidewall 1041 of the notch structure 104 is aligned with the lens portion of the lens structure 101 along the Z-axis direction; for instance, an optical axis 101A of the lens structure 101 can extend through a point of the sidewall 1041 of the notch structure 104. In some embodiments, the angle θ between the sidewall 1041 of the notch structure 104 and a surface of the second side 100B may be about 45 degrees, so as to properly and substantially change a direction of the light beam from the X-axis direction to the Z-axis direction at the sidewall 1041 of the notch structure 104 in a reflection manner. The geometry of the notch structure 104 can vary in different embodiments. In some embodiments, the notch structure 104 may include a V-shaped groove or a slanted surface (see FIG. 3). In other words, the projection of the lens structure 101 along the Z-axis direction may be within the range of the sidewall 1041 of the notch structure 104.

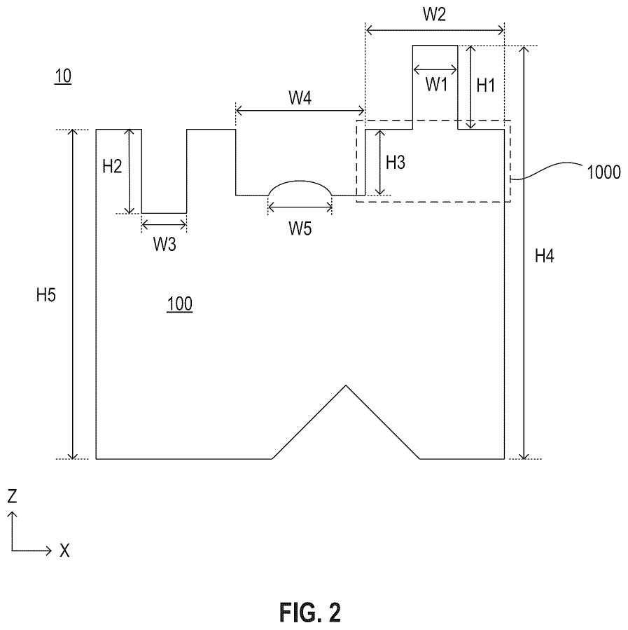

Referring to FIG. 2, which illustrates a cross-sectional view of the optical component 10 according to some embodiments of the present disclosure, some labels shown in FIG. 1 are not shown in FIG. 2 for brevity. In some embodiments, a height H4 of the lens body 100 is in a range from about 500 μm to about 1,000 μm, for example, as about 750 μm. A height H1 of the first engaging structure 102 is less than or equal to a depth H2 of the second engaging structure 103. For example, both the height H1 and the depth H2 are about 150 μm, or the depth H2 is about 150 μm and the height H1 is less than about 150 μm. The height H5 (i.e., the height of the lens body 100 without the first engaging structure 102) is greater than the depth H2. In some embodiments, the depth H2 is equal to or less than about 50% of the height H5. In some embodiments, the depth H2 is equal to or less than about 30% of the height H5. In some embodiments, the depth H2 is as in a range from about 5% to about 30% of the height H5. In some embodiments, the depth H2 is as in a range from about 10% to about 30% of the height H5.

In some embodiments, the width W1 of the first engaging structure 102 is less than or equal to the width W3 of the second engaging structure 103. In some embodiments, the width W1 of the first engaging structure 102 is substantially identical to or at least close to the width W3 of the second engaging structure 103 for a tight connection between two identical optical components. In some embodiments, the width W5 of the lens portion (e.g., the convex lens 1010 labeled in FIG. 1) is less than the width W4 of the lens-containing recess 105. Accordingly, the lens portion can be laterally surrounded by a plain portion at the bottom of the lens-containing recess 105. In some embodiments, the width W4 is in a range from about 100 μm to about 200 μm. In some embodiments, the width W2 of a bulk portion 1000 under the first engaging structure 102 and adjacent to the lens-containing recess 105 is greater than the width W4 of the lens-containing recess 105. In some embodiments, a depth H3 of the lens-containing recess 105 is greater than a height of the lens portion of the lens structure 101. In some embodiments, the depth H2 of the second engaging structure 103 is equal to or greater than the depth H3 of the lens-containing recess 105. In other embodiments, the depth H2 of the second engaging structure 103 is less than the depth H3 of the lens-containing recess 105. In some embodiments, the depth H3 of the lens-containing recess 105 is greater than a radius of curvature of the portion (e.g., the convex lens 1010 labeled in FIG. 1), and comparable to the depth H2 of the second engaging structure 103. In some embodiments, the depth H3 is about 150 μm. In some embodiments, the lens structure 101 is located at a center position between the first engaging structure 102 and the second engaging structure 103 along the X-axis direction.

In some embodiments, referring to FIG. 3, the lens body 100 of the optical component 10 includes the lens structure 101, the first engaging structure 102, the second engaging structure 103 and a notch structure 104′. The configuration of embodiment in FIG. 3 is basically the same as the embodiment in FIG. 1, and one of the differences between the embodiments shown in FIGS. 1 and 3 is that the notch structure 104′ in the embodiment shown in FIG. 3 includes a slanted surface 1041′. The geometry of the notch structure 104′ is not limited as long as the surface of the notch structure 104′ is capable of changing the direction of optical path and guiding the light beam to/from the lens structure 101.

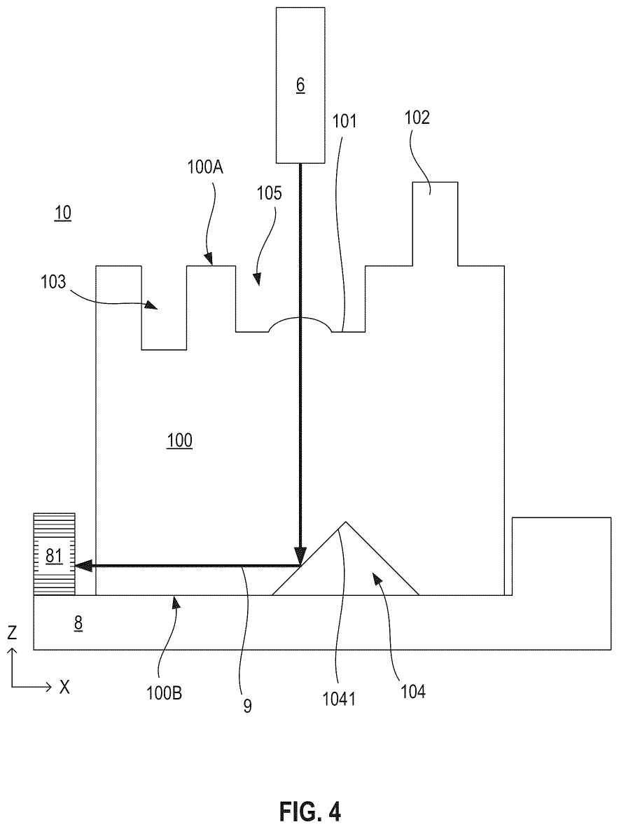

In the practical application aspect, a single optical component can be used for vertical coupling application. In some embodiments, referring to FIG. 4, a light beam 9 outputted from an optical fiber 6 (e.g., a Fiber Array Unit, FAU) enters the lens portion of the lens structure 101 and is subsequently reflected by the sidewall 1041 of the notch structure 104, before it enters waveguides 81 in the optical chip 8 (e.g., a Photonic Integrated Circuit, PIC) adjacent to the optical component 10. Similarly, in a light path opposite to that shown in FIG. 4, the light beam 9 outputted from the optical chip 8 (e.g., PIC) can enter the optical component 10 and is reflected by the sidewall 1041 of the notch structure 104, before the light beam 9 is collimated by the lens portion of the lens structure 101; the light beam 9 can subsequently enter the optical fiber 6 (e.g., FAU). That is, by the vertical alignment of the lens structure 101 and the sidewall 1041 of the notch structure 104, the optical component 10 can be used to change the optical path of the light beam 9 outputted by the optical chip 8 or the optical fiber 6 by about 90 degrees (i.e., from the X-axis direction to the Z-axis direction).

In some embodiments, the wavelength of the light beam 9 can fall within an infrared light range. In this embodiment, the material of the lens body 100 can be choose based on its transmittance to infrared light. In some embodiments, the transmission loss can be controlled by enhancing the occurrence of complete reflection at the interface between the lens body 100 and the air (e.g., at the sidewall 1041 of the notch structure 104). For example, since silicon (Si) has a good transmittance to the infrared light, and has a high refractive index than that of the air, a silicon-based substrate can be used for manufacturing the lens body 100 of the optical component 10. In addition, as can be understood with reference to FIG. 4, the focal length of the lens structure 101 can be determined by the allowed divergence angle of the light beam 9 transmitted in the waveguide of the optical chip 8, the more divergent the light beam 9, the shorter the focal length of the lens structure 101.

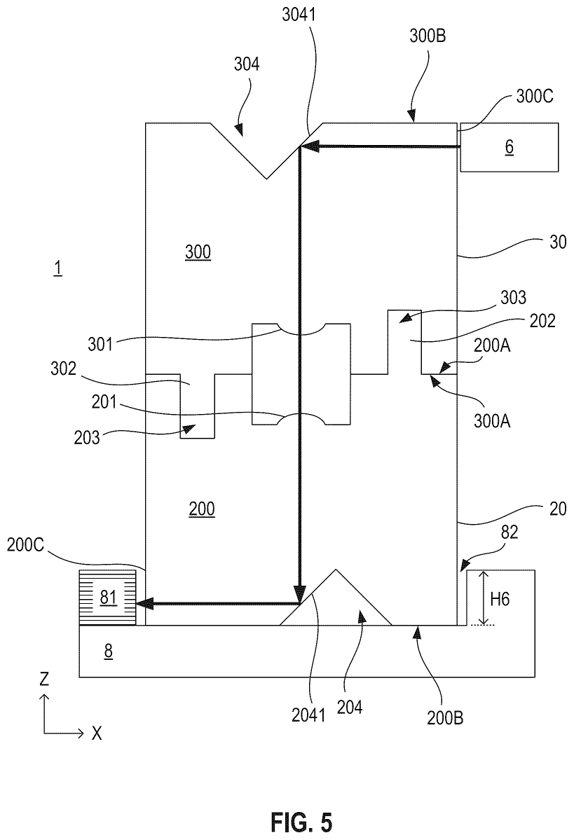

In addition to solely using one optical component 10 for vertical coupling application, in other embodiments, two optical components can be combined to form an optical module for horizontal edge coupling application. FIG. 5 illustrates a cross-sectional view of an optical module 1 according to some embodiments of the present disclosure. In some embodiments, the optical module 1 includes a first optical component 20 and a second optical component 30 stacked over the first optical component 20. The profile of the first optical component 20 is substantially identical to the profile of the second optical component 30. Each of the first optical component 20 and the second optical component 30 includes a lens body 200/300. The lens body 200/300 has a first side and a second side opposite to the first side. The lens body 200/300 includes a lens structure 201/301, a first engaging structure 202/302, a second engaging structure 203/303 and a notch structure 204/304. The lens structure 201/301 is located at the first side 200A/300A of the lens body 200/300. The first engaging structure 202/302 and the second engaging structure 203/303 are also located at the first side 200A/300A of the lens body 200/300, and the first engaging structure 202/302 and the second engaging structure 203/303 are located at two opposite lateral sides of the lens structure 201/301. The notch structure 204/304 are located at the second side of the lens body 200/300, and the notch structure 204/304 has a sidewall 2041/3041 vertically aligned with the lens structure 201/301. A profile of the first engaging structure 202 of the first optical component 20 is engageable with a profile of the second engaging structure 303 of the second optical component 30, and a profile of the first engaging structure 302 of the second optical component 30 is engageable with a profile of the second engaging structure 203 of the first optical component 20.

In the embodiment shown in FIG. 5, each of the first optical component 20 and the second optical component 30 is substantially the same as the optical component 10 shown in FIG. 1, and the repeated description is omitted here for brevity. The second optical component 30 can be stacked over the first optical component 20 through the engagement of the corresponding engaging structures. For instance, the first optical component 20 can be inverted in orientation (i.e., flipped 180 degrees) to let the first side 200A of the first optical component 20 engaging with the first side 300A of the second optical component 30. Since the profile of the first engaging structure 202 of the first optical component 20 is engageable with the profile of the second engaging structure 303 of the second optical component 30, and the profile of the first engaging structure 302 of the second optical component 30 is engageable with the profile of the second engaging structure 203 of the first optical component 20, the two optical components can be combined and assembled to be a single optical component (e.g., the optical module 1). In some embodiments, an interface between the first optical component 20 and the second optical component 30 is free from having an adhesion material.

In some embodiments, since the relative position of the first engaging structure 202/302 and the second engaging structure 203/303 are matched, the lens structures 201/301 are passively aligned as long as the first optical component 20 and the second optical component 30 are engaged. In some embodiments, once the first optical component 20 and the second optical component 30 are combined/assembled, the first lens-containing recess 205 of the first optical component 20 is vertically aligned to the second lens-containing recess 305 of the second optical component 30. Also, the first lens structure 201 of the first optical component 20 is vertically aligned to the second lens structure 301 of the second optical component 30. That is, the alignment of the two optical components can be performed by the corresponding engaging structures on one side thereof.

Still referring to FIG. 5, in some embodiments, a reflective surface (e.g., the sidewall 2041) of the notch structure 204 of the first optical component 20 is parallel to a reflective surface (e.g., the sidewall 3041) of the notch structure 304 of the second optical component 30. In some embodiments, a profile of the first optical component 20 is substantially identical to a profile of the second optical component 30. Accordingly, by combing these optical components, the light beam 9 may be incident on the optical module 1 along the X-axis direction, and transmitted out of the optical module 1 along the X-axis direction and having a displacement along the Z-axis direction.

In some embodiments, the optical module 1 can be used for edge coupling application. For instance, as shown in FIG. 5, the light beam 9 may output from the optical fiber 6 (e.g., FAU) and enter the second optical component 30 at a lateral side 300C of the second optical component 30. The light can be reflected by the sidewall 3041 and collimated by the second lens structure 301 and the first lens structure 201 subsequently. It is then be reflected by the sidewall 2041 before exiting the first optical component 20 at a lateral side 200C of the first optical component 20. The light can then enter the waveguides in the optical chip 8 (e.g., PIC). Similarly, in a light path opposite to that shown in FIG. 5, the light beam 9 may output from the optical chip (e.g., PIC) and enter the first optical component 20 at the lateral side 200C of the first optical component 20 and then be reflected by the sidewall 2041, collimated by the first lens structure 201 and the second lens structure 301 subsequently, and then be reflected by the sidewall 3041 before exiting the second optical component 30 at the lateral side 300C of the second optical component 30 and entering the optical fiber 6 (e.g., FAU).

In some embodiments, the optical module 1 is placed in a recess 82 at a top surface of the optical chip 8 (e.g., PIC). The depth H6 of the recess 82 can be determined based on several factors, e.g., the depth of the optical chip 8 (e.g., PIC) allowed to be removed without compromising PIC's performance. In some embodiments, the depth H6 of the recess 82 is from about 30 μm to about 100 μm. In some embodiments, the depth H6 of the recess 82 can be greater than about 100 μm.

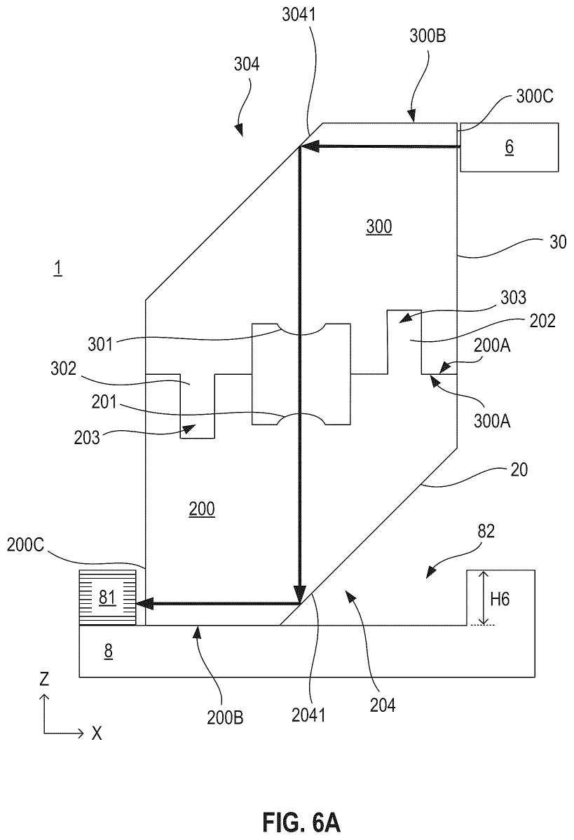

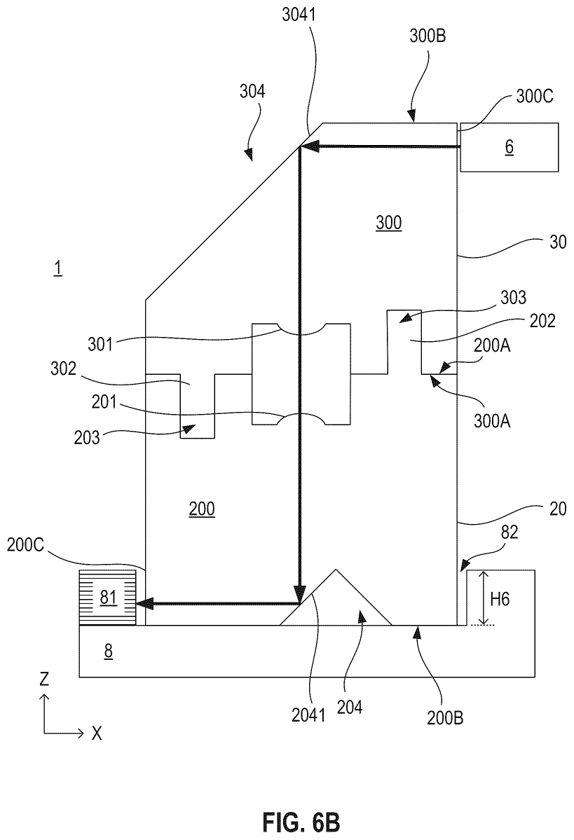

FIG. 6A illustrates a cross-sectional view of an optical module according to some embodiments of the present disclosure. Referring to FIG. 6A, the first optical component 20 and the second optical component 30 are substantially identical to those previously described in the present disclosure except the profiles of the notch structure thereof, and the optical module 1 is substantially identical to the embodiment shown in FIG. 5, so the repeated description is omitted here for brevity. In this embodiment, the first notch structure 204′ and the second notch structure 304′ can each be a slanted surface. The geometry of the notch structure is not limited as long as the reflective surface is capable of changing the direction of the optical path of light beam 9.

In further alternative embodiments, the combined/assembled optical components may have different profiles at the notch structures. For instance, as shown in FIG. 6B, the first optical component 20 without having the slanted surface (e.g., the first optical component 20 shown in FIG. 5) can be combined with the second optical component 30 having the slanted surface (e.g., the second optical component 30 shown in FIG. 6A), and vice versa.

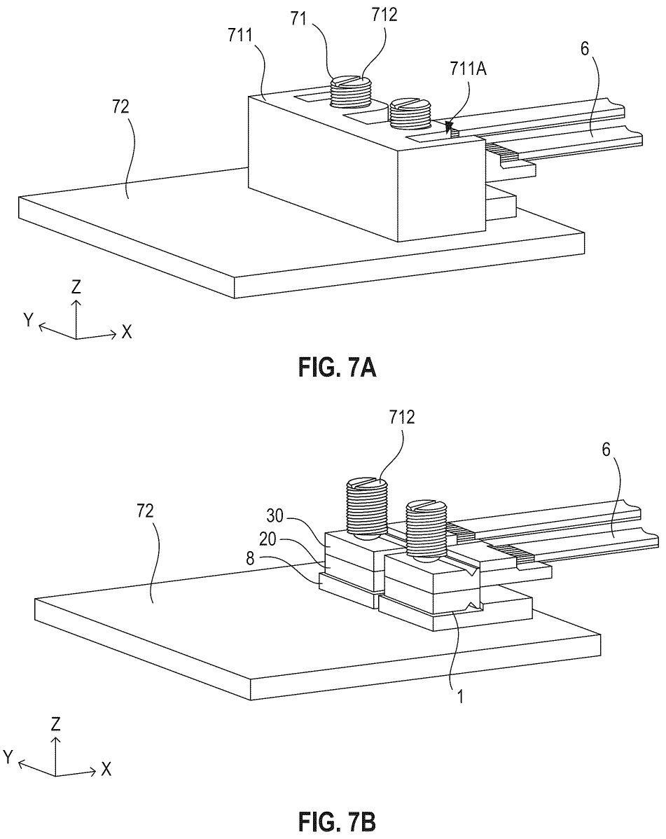

FIGS. 7A and 7B illustrate three-dimensional views of an optical module according to some embodiments of the present disclosure, wherein a fixing cap is removed from FIG. 7B for showing the structures shield by the fixing cap in FIG. 7A. Referring to FIGS. 7A and 7B, in some embodiments, the optical module 1 may further include a fixing component 71 and a substrate 72. The substrate 72 is disposed under the first optical component 20, the second optical component 30, and the optical chip 8 (e.g., PIC) and thus used as a carrier. In some embodiments, the fixing component 71 is disposed on the substrate 72, configured to fix the first optical component 20 and the second optical component 30 on the substrate 72. For example, the fixing component 71 may fix the optical components on the substrate 72 from the second side 300B of the second optical component 30 in the scenario that the second optical component 30 is stacked over the first optical component 20. By using the fixing component 71, no adhesive is applied to any part of the optical module 1 after the engagement of the optical components.

In some embodiments, the fixing component 71 may include one or more fixing mechanisms, such as set screws 712 or spring leaves. The fixing mechanisms are positioned over the first optical component 20 and the second optical component 30 to secure these optical components to the substrate 72. In some embodiments, the set screws 712 can work with a fixing cap 711 (sec FIG. 7A) positioned on the substrate 72. In some embodiments, the fixing cap 711 may have a plurality of sockets 711A for positioning the optical fiber 6 (e.g., FAU) at a side of the optical module 1.

In some embodiments, the set screw(s) 712 can be removably engaged with the fixing cap 711 through one or more fixture holes in the fixing cap 711, and the strength of fixture can be adjusted by varying the vertical depth of the set screw 712 within the fixing cap 711. As aforementioned, the fixing cap 711 is designed to at least partially accommodate the optical module 1 and the optical chip 8 (e.g., PIC), with one side open (e.g., the sockets 711A) to receive the optical fiber 6 (e.g., FAU). By pressing against the stack of the first optical component 20 and the second optical component 30 through the fixing mechanisms (e.g., set screws 712), it can be ensured that the first optical component 20 and the second optical component 30 being butted against each other without relative movement prior to, during, or after operation.

In some embodiments, the fixing cap 711 can be used to secure two or more sets of stacked optical components arranged in a row or an array; the fixing cap 711 can be designed or customized based on the arrangement of CPO. In some embodiments, the fixing mechanism may not be directly over the stack of the first optical component 20 and the second optical component 30. For example, in the scenario that the fixing cap 711 is flexible, the fixing mechanism can be placed near the lateral sides of the stacked optical components, providing the pressure towards the fixing cap 711 over the stacked optical components to secure the positions of the stacked optical components.

In some embodiments, the notch structures of the first optical component 20 and the second optical component 30 can be vertically aligned. For example, the profiles of the first optical component 20 and the second optical component 30 can be mirror-symmetric with respect to the interface when viewed from the side of the stack of these optical components, such as from the perspective at the X-Z plane in FIG. 7B. In such embodiments, the light beam passing through the stack of the first optical component 20 and the second optical component 30 can be reflected twice by the mirror-symmetric sidewalls of the two notch structures, resulting in a 180-degree change in direction. Therefore, the optical chip 8 (e.g., PIC) and the optical fiber 6 (e.g., FAU) can be positioned on the same side of the stack of optical components.

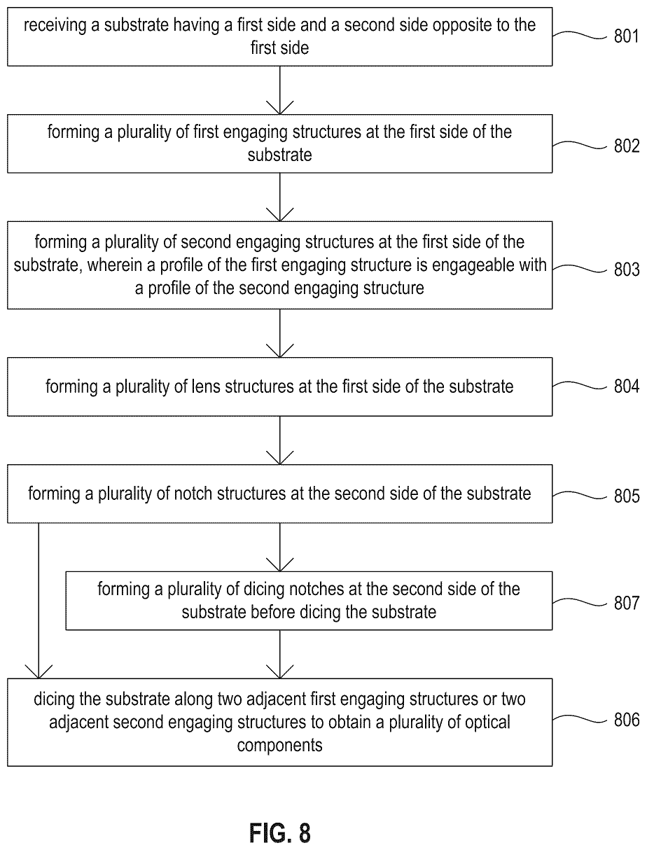

FIG. 8A illustrates a flow chart of a method for manufacturing an optical component according to some embodiments of the present disclosure. Referring to FIG. 8, in some embodiments, the method for manufacturing the optical component includes: an operation 801: receiving a substrate having a first side and a second side opposite to the first side; an operation 802: forming a plurality of first engaging structures at the first side of the substrate; an operation 803: forming a plurality of second engaging structures at the first side of the substrate, wherein a profile of the first engaging structure is engageable with a profile of the second engaging structure; an operation 804: forming a plurality of lens structures at the first side of the substrate; an operation 805: forming a plurality of notch structures at the second side of the substrate; and an operation 806: dicing the substrate along two adjacent first engaging structures or two adjacent second engaging structures to obtain a plurality of optical components. In some embodiments, the method for manufacturing the optical component may further include: an operation 807: forming a plurality of dicing notches at the second side of the substrate before dicing the substrate (i.e., the operation 806).

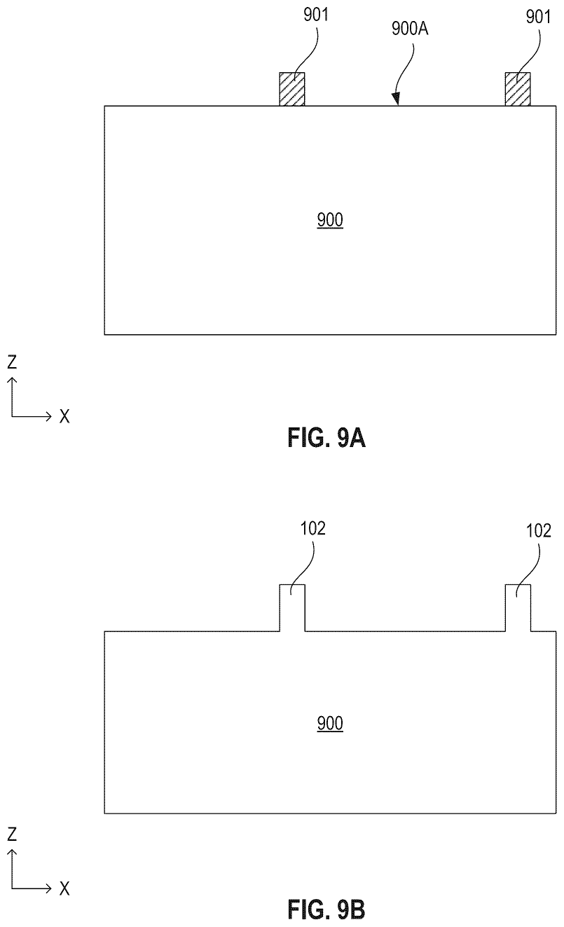

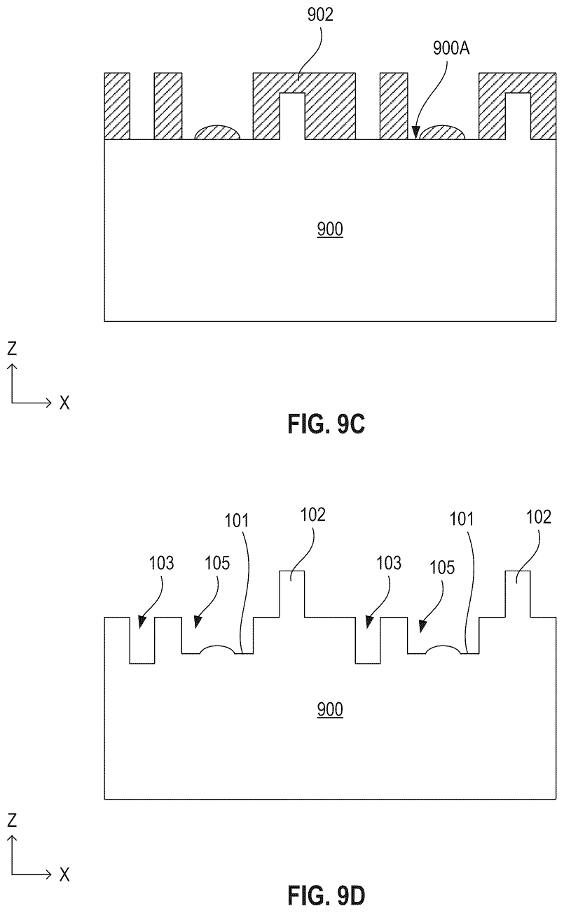

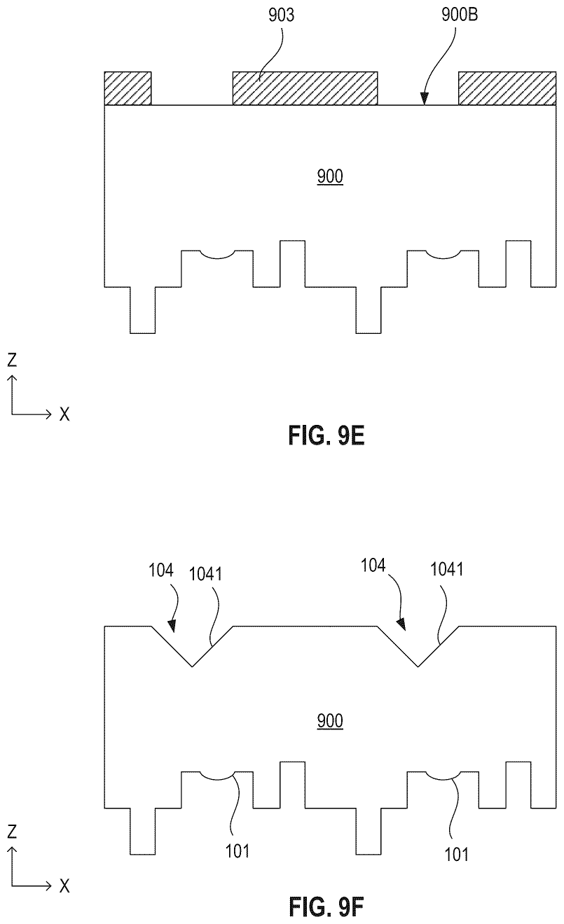

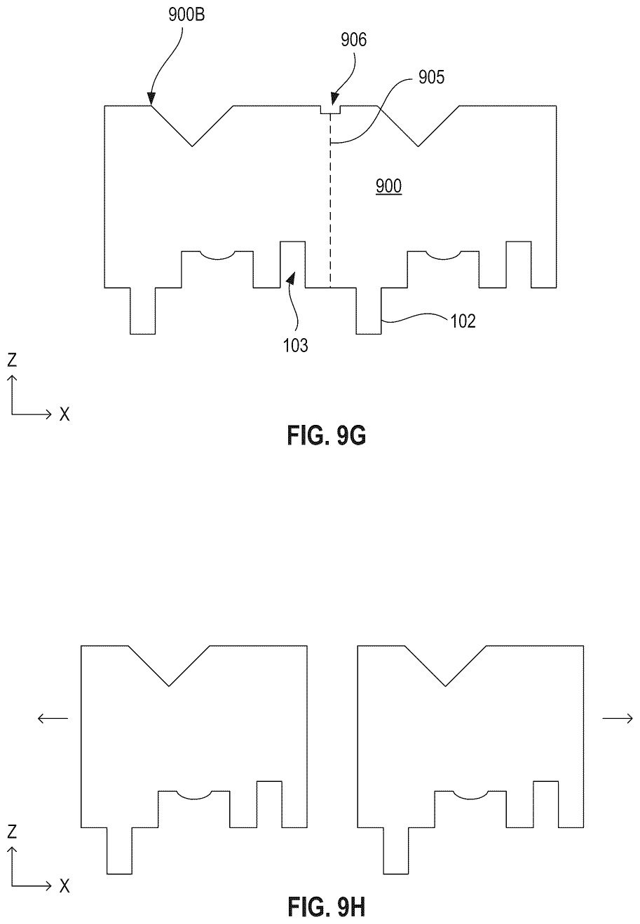

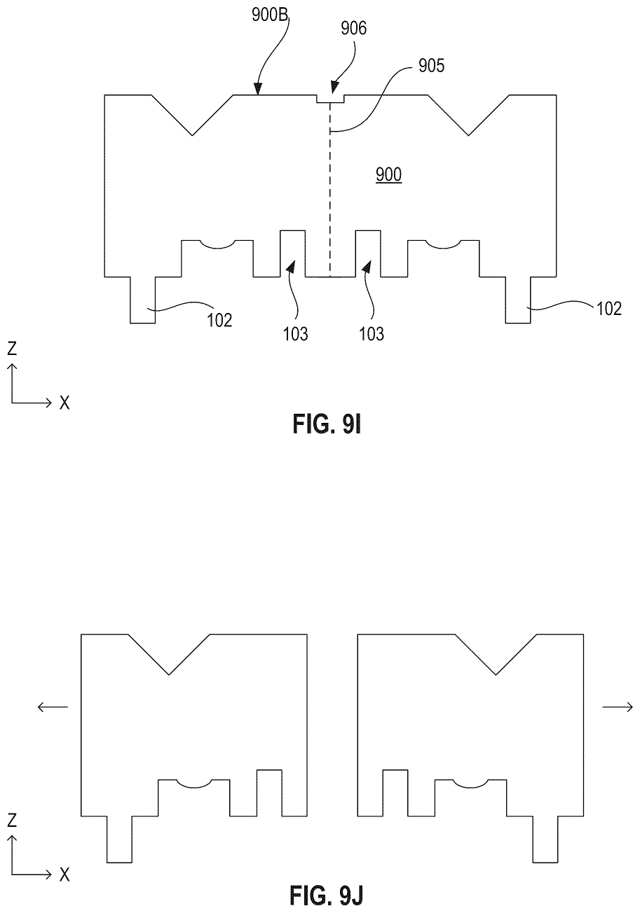

In some embodiments, a substrate that is suitable for semiconductor manufacturing process and light transmission can be prepared and used as the lens body of the optical component. For example, the substrate may be a silicon-based substrate. Referring to FIGS. 9A and 9B, in some embodiments, one or more of protutions (i.e., the first engaging structures 102) can be formed at a first side 900A of a substrate 900 for forming the lens body 100 previously shown in FIG. 1 through a patterning operation to the substrate 900 by using a first photoresist 901. Referring to FIGS. 9C and 9D, in some embodiments, one or more receptacle recesses (i.e., the second engaging structures 103) and one or more lens-containing recesses (i.e., the lens structures 101 each including a lens-containing recess 105) can be formed at the first side 900A of the substrate 900 through at least another patterning operation to the substrate 900 by using a second photoresist 902. Next, referring to FIGS. 9E and 9F, in some embodiments, one or more oblique portions (i.e., the notch structures 104) can be formed at a second side 900B of the substrate 900 through a patterning operation to the substrate 900 by using a third photoresist 903. In some embodiments, the notch structure 104 includes an etching surface (e.g., the sidewall 1041) vertically aligned to the lens structure 101. In some embodiments, the patterning operations may include one or more etching processes that can be wet etch, dry etch, or combinations thereof.

In some embodiments, forming the plurality of second engaging structures 103 and forming the plurality of lens structures 101 are performed in a single etch operation, and a depth of the second engaging structure 103 is substantially identical to a depth of lens-containing recess 105 of the lens structure 101.

Referring to FIG. 9G, in some embodiments, a plurality of dicing notches 906 can be formed at a default border 905 between adjacent optical components at the second side 900B of the substrate 900. In some embodiments, the dicing notch 906 can be formed by an etching process that can be wet etch, dry etch, or combinations thereof. The dicing notch 906 at the second side 900B of the substrate 900 can be formed prior to or after forming the first engaging structure 102, the lens-containing recess 105 and the second engaging structure 103 at the first side 900A of the substrate 900.

Referring to FIG. 9H, in some embodiments, the substrate 900 can be diced along two adjacent engaging structures (e.g., two adjacent first engaging structures 102, two adjacent second engaging structures 103 or one pair of the first and the second engaging structures 102, 103, depending on the patterning operations in forming these engaging structures at the first side 900A of the substrate 900, the embodiment shown in FIGS. 9A-9H uses the pair of the first and the second engaging structures 102, 103 for example) to obtain a plurality of optical components. In other embodiments, two of the optical components are mirror-symmetric along a dicing surface (e.g., the default border 905) between the two adjacent first engaging structures 102 or the two adjacent second engaging structures 103, such as the example shown in FIGS. 9I and 9J. In some embodiments, this dicing process is facilitated by the dicing notch 106 pre-formed at the second side 900B of the substrate 900, and the planeness (e.g., the surface roughness (Ra)) of the diced surface, which will be used as a light-entering surface or a light-exiting surface, can be controlled at a suitable extent. By virtue of semiconductor manufacturing process, the surface roughness (Ra) can reach about 1 μm or better.

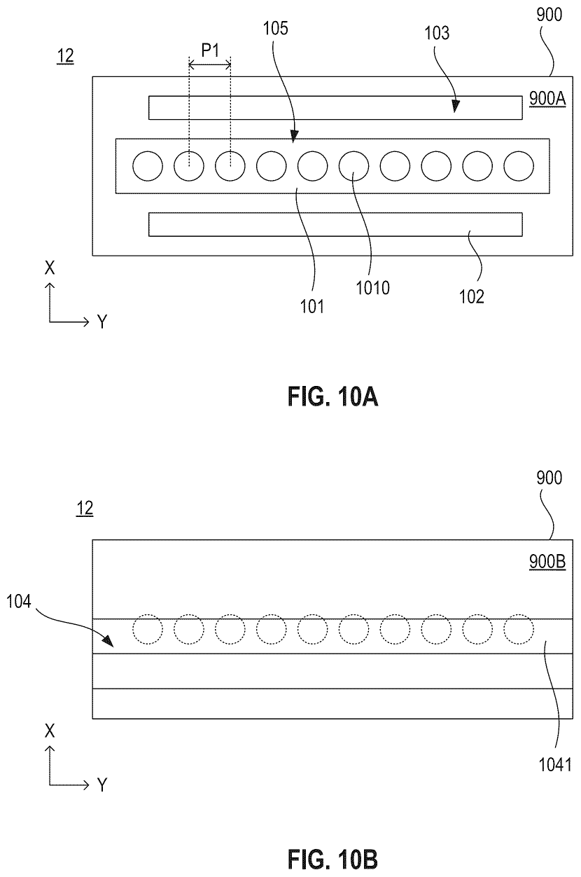

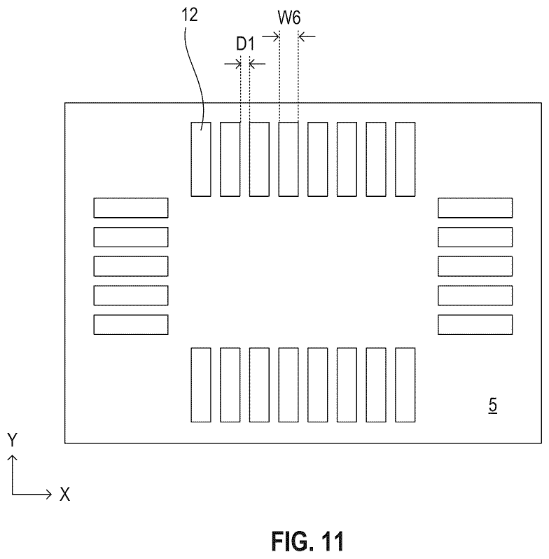

In some embodiments, a plurality of optical components can be integrated to achieve a high density integration in a CPO, such a bar-shaped optical component 12. As shown in FIG. 10A, a continuous bar-shaped protrusion extending along the Y-axis direction is formed at the first side 900A of the substrate 900 to serve as the first engaging structure 102 of the optical component, and a continuous trench extending along the Y-axis direction is formed at the first side 900A of the substrate 900 to serve as the second engaging structure 103 of the optical component. Similarly, in some embodiments, the lens-containing recess 105 is formed, which extends along the Y-axis direction, and there are a plurality of lens portions (e.g., the convex lens 1010) formed at the bottom of the lens-containing recess 105. That is, the lens-containing recess 105 and the plurality of lens portions are formed to be the lens structures 101 of the optical component having a bar-shaped profile along the Y-axis direction. In some embodiments, a pitch P1 of adjacent lens portions within the lens-containing recess 105 is in a range from about 100 μm to about 200 μm. As shown in FIG. 10B, a continuous trench extending along the Y-axis direction can be formed at the second side 900B of the substrate 900 to serve as the notch structure 104 of the optical component, wherein the positions of the lens portions (e.g., the convex lens 1010) at the first side 900A of the substrate 900 are illustrated in dotted line for reference.

Referring to FIG. 11, in some embodiments, a plurality of optical components 12 can be integrated on a CPO platform 5. Each of the optical components 12 can be arranged side-by-side (i.e., the side with primary dimension along the Y-axis direction of one optical component 12 facing the primary side along the Y-axis direction of adjacent optical component 12) along secondary dimension (the X-axis direction) so as to achieve compact packaging arrangement. Optionally, each optical component 12 can laterally engage with the adjacent optical component 12 by suitable mechanical fixture, for example but not limited to, the protrusion and the receptacle recess described herein, to further enhance the lateral compact packaging arrangement. In some embodiments, a distance D1 between two adjacent optical components 12 is less than a width W6 of the optical components 12 under a dense arrangement. In some embodiments, the CPO platform 5 can include the substrate 72 shown in FIG. 7A, or, the CPO platform 5 can include the substrate 72 and the optical chip 8 shown in FIG. 7A.

In the present disclosure, there are a number of embodiments of optical components and optical modules that can provide the function of optical fiber-to-chip interconnection application. Overall, among the embodiments, in the scenario that a single optical component is used, the lens structure is configured to collimate the incident light beam, and the notch structure is configured to reflect the light beam and change the direction of the optical path. In the scenario that two optical component are stacked and combined, the first engaging structure and the second engaging structure at one side thereof are configured to compatibly engaging with each other, and the lens structures and the notch structures of the two optical components are configured to collimate and reflect the light beam. There are some variations in embodiments of the present disclosure. For instance, within a combination of two optical components, these two optical components can have identical profile, and so that not only the engagement of these two optical components is solid and secured, but also no additional beam alignment is required within the combination. In addition, the identical geometry of the two optical components can simplify the manufacturing process. In the practical application aspect, the optical components and the optical module in the present disclosure can be used in edge coupling for optical fibers and optical chips. For instance, the optical module can be placed at a recess of the optical chip and positioned and secured by a fixing mechanism. According to the present disclosure, it can be recognized that there are more optical component and/or optical module embodiments that can be achieved by using different combinations of the different types of some detailed change in the lens structure, engaging structure and the notch structure in a single optical component. Since the principles and functions of these portions are the same, other feasible embodiments of the optical modules are omitted here for brevity.

In one exemplary aspect, an optical component is provided. The optical component includes a lens body having a first side and a second side opposite to the first side. The lens body includes a lens structure, a first engaging structure, a second engaging structure and a notch structure. The lens structure is located at the first side of the lens body. The first engaging structure and the second engaging structure are located at the first side of the lens body, a profile of the first engaging structure is engageable with a profile of the second engaging structure, and the first engaging structure and the second engaging structure are located at two opposite sides of the lens structure. The notch structure is located at the second side of the lens body, and the notch structure has a sidewall vertically aligned with the lens structure.

In another exemplary aspect, an optical module is provided. The optical module includes a first optical component and a second optical component stacked over the first optical component. Each of the first optical component and the second optical component includes a lens body having a first side and a second side opposite to the first side, and the lens body includes a lens structure, a first engaging structure, a second engaging structure and a notch structure. The lens structure is located at the first side of the lens body. The first engaging structure and the second engaging structure are located at the first side of the lens body, and the first engaging structure and the second engaging structure are located at two opposite sides of the lens structure. The notch structure is located at the second side of the lens body, and the notch structure has a sidewall vertically aligned with the lens structure. A profile of the first engaging structure of the first optical component is engageable with a profile of the second engaging structure of the second optical component, and a profile of the first engaging structure of the second optical component is engageable with a profile of the second engaging structure of the first optical component.

In yet another exemplary aspect, a method for manufacturing an optical component is provided. The method includes the following operations. A substrate having a first side and a second side opposite to the first side is received. A plurality of first engaging structures are formed at the first side of the substrate. A plurality of second engaging structures are formed at the first side of the substrate, wherein a profile of the first engaging structure is engageable with a profile of the second engaging structure. A plurality of lens structures are formed at the first side of the substrate. A plurality of notch structures are formed at the second side of the substrate. The substrate is diced along two adjacent first engaging structures or two adjacent second engaging structures to obtain a plurality of optical components.

The foregoing outlines structures of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. An optical component, comprising:
a lens body having a first side and a second side opposite to the first side, comprising:
a lens structure at the first side of the lens body;
a first engaging structure and a second engaging structure at the first side of the lens body, a profile of the first engaging structure is engageable with a profile of the second engaging structure, the first engaging structure and the second engaging structure are located at two opposite sides of the lens structure; and
a notch structure at the second side of the lens body, the notch structure has a sidewall vertically aligned with the lens structure.

2. The optical component of claim 1, wherein the lens structure is located between the first engaging structure and the second engaging structure.

3. The optical component of claim 1, wherein a bottom of the first engaging structure is leveled with a top of the second engaging structure.

4. The optical component of claim 1, wherein the lens structure comprises a lens-containing recess at the first side of the lens body.

5. The optical component of claim 4, wherein a width of a bulk portion under the first engaging structure and adjacent to the lens-containing recess is greater than a width of the lens-containing recess.

6. The optical component of claim 4, wherein a depth of the lens-containing recess is greater than a height of a lens portion in the lens structure.

7. The optical component of claim 1, wherein a height of the first engaging structure is less than or equal to a depth of the second engaging structure.

8. The optical component of claim 1, wherein the notch structure comprises a V-shaped groove or a slanted surface.

9. An optical module, comprising a first optical component and a second optical component stacked over the first optical component, and each of the first optical component and the second optical component comprising:
a lens body having a first side and a second side opposite to the first side, comprising:
a lens structure at the first side of the lens body;
a first engaging structure and a second engaging structure at the first side of the lens body, and the first engaging structure and the second engaging structure are located at two opposite sides of the lens structure; and
a notch structure at the second side of the lens body, the notch structure has a sidewall vertically aligned with the lens structure,
wherein a profile of the first engaging structure of the first optical component is engageable with a profile of the second engaging structure of the second optical component, a profile of the first engaging structure of the second optical component is engageable with a profile of the second engaging structure of the first optical component.

10. The optical module of claim 9, wherein an interface between the first engaging structure of the first optical component and the second engaging structure of the second optical component is free from having an adhesion material.

11. The optical module of claim 9, wherein the first engaging structure comprises a protrusion portion, and the second engaging structure comprises a receptacle recess.

12. The optical module of claim 9, wherein the first optical component and the second optical component further comprises a first lens-containing recess and a second lens-containing recess, respectively, wherein the first lens-containing recess is vertically aligned to the second lens-containing recess.

13. The optical module of claim 9, wherein a reflective surface of the notch structure of the first optical component is parallel to a reflective surface of the notch structure of the second optical component.

14. The optical module of claim 9, wherein a profile of the first optical component is substantially identical to a profile of the second optical component.

15. The optical module of claim 9, further comprising:
a substrate under the first optical component and the second optical component; and
a fixing mechanism over the first optical component and the second optical component, configured to fix the first optical component and the second optical component on the substrate.

16. A method for manufacturing an optical component, the method comprising:
receiving a substrate having a first side and a second side opposite to the first side;
forming a plurality of first engaging structures at the first side of the substrate;
forming a plurality of second engaging structures at the first side of the substrate, wherein a profile of the first engaging structure is engageable with a profile of the second engaging structure;
forming a plurality of lens structures at the first side of the substrate;
forming a plurality of notch structures at the second side of the substrate; and
dicing the substrate along two adjacent first engaging structures or two adjacent second engaging structures to obtain a plurality of optical components.

17. The manufacturing process of claim 16, further comprising:
forming a plurality of dicing notches at the second side of the substrate before dicing the substrate.

18. The manufacturing process of claim 16, wherein the notch structure comprises an etching surface vertically aligned to the lens structure.

19. The manufacturing process of claim 16, wherein two of the optical components are mirror-symmetric along a dicing surface between the two adjacent first engaging structures or the two adjacent second engaging structures.

20. The manufacturing process of claim 16, wherein forming the plurality of second engaging structures and forming the plurality of lens structures are performed in a single etch operation, a depth of the second engaging structure is substantially identical to a depth of lens-containing recess of the lens structure.
